(19) United States
(12) Patent Application Publication
(10) Pub. No.: US 2026/0196419 A1
(43) Pub. Date: Jul. 9, 2026

(54) KEY DEVICE

(71) Applicant: SUNREX TECHNOLOGY CORP., Taichung City (TW)

(72) Inventors: Yin CHU, Chongqing City (CN); Dai-Qiang GAO, Chongqing City (CN); Bao-Song MA, Chongqing City (CN); Shih-Pin LIN, Taichung City (TW)

(73) Assignee: SUNREX TECHNOLOGY CORP., Taichung City (TW)

(21) Appl. No.: 19/181,873

(22) Filed: Apr. 17, 2025

(30) Foreign Application Priority Data
Jan. 3, 2025 (TW) 114100347

(51) Int. Cl. H01H 13/14; H01H 13/10

(52) U.S. Cl. CPC H01H 13/14; H01H 13/10

(57) ABSTRACT

A key device includes a circuit board unit, a base unit, and a key unit. The base unit is disposed on the circuit board unit and has a base opening. The key unit includes a support module, a keycap module, and an elastic member. The support module is disposed on the base unit. The keycap module is disposed on the support module, and has a lower cap body that is disposed on the support module and that has a through hole, and an upper cap body that is disposed above the lower cap body. The elastic member has a bottom end that extends through the base opening of the base unit and that abuts against the circuit board unit, and a top end that extends through the through hole of the lower cap body and that abuts against the upper cap body.

### CROSS-REFERENCE TO RELATED APPLICATION

This application claims priority to Taiwanese Invention Patent Application No. 114100347, filed on Jan. 3, 2025, the entire disclosure of which is incorporated by reference herein.

### FIELD

The disclosure relates to an input device, and more particularly to a key device.

### BACKGROUND

An existing key device includes a backlight module, a base plate disposed above the backlight module, a membrane circuit board disposed above the base plate, and a plurality of keycap units disposed on the base plate. The base plate has a plurality of hook modules. The membrane circuit board has a plurality of hook holes which the hook modules respectively extend through. Each of the keycap units includes a scissor-type mechanism connected to a respective one of the hook modules, a keycap disposed on the scissor-type mechanism, and an elastic member connected to the keycap and the membrane circuit board. When the keycap is pressed, the elastic member presses the membrane circuit board such that the membrane circuit board generates an electrical signal.

However, it is difficult to reduce a thickness of the existing key device. Because the keycap of each of the keycap units is made of a plastic material, when trying to reduce a thickness of the keycap, thinning of the keycap during plastic injection molding may cause the keycap to be unevenly cooled, thereby resulting in the keycap to be less flat. If a thickness of the elastic member is reduced, a distance between the keycap of each of the keycap units and the membrane circuit board is reduced, thereby causing a travel distance of the existing key device to be reduced and resulting in unsatisfactory pressing feedback.

### SUMMARY

Therefore, an object of the disclosure is to provide a key device that can alleviate at least one of the drawbacks of the prior art.

According to the disclosure, the key device includes a circuit board unit, a base unit, and a key unit.

The base unit is disposed above the circuit board unit and has a base opening.

The key unit includes a support module, a keycap module, and an elastic member. The support module is disposed on the base unit. The keycap module is disposed on the support module and has a lower cap body and an upper cap body. The lower cap body is disposed on the support module and has a through hole. The elastic member has a bottom end and a top end. The bottom end extends through the base opening of the base unit and abuts against the circuit board unit. The top end extends through the through hole of the lower cap body and abuts against the upper cap body.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view illustrating a key device according to an embodiment of the disclosure.

FIG. 2 is an exploded perspective view of the embodiment illustrating the key device.

FIG. 3 is a sectional view of the embodiment illustrating the key device.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

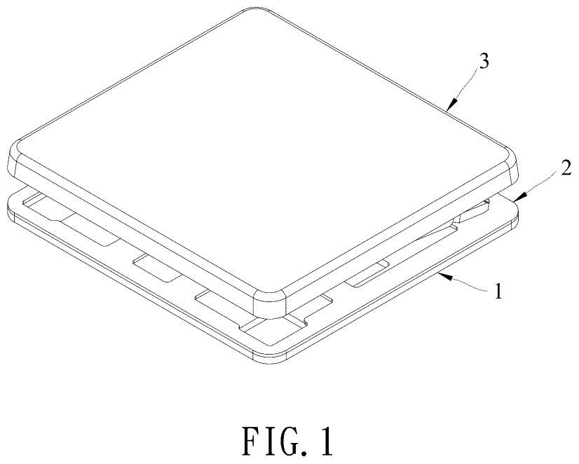

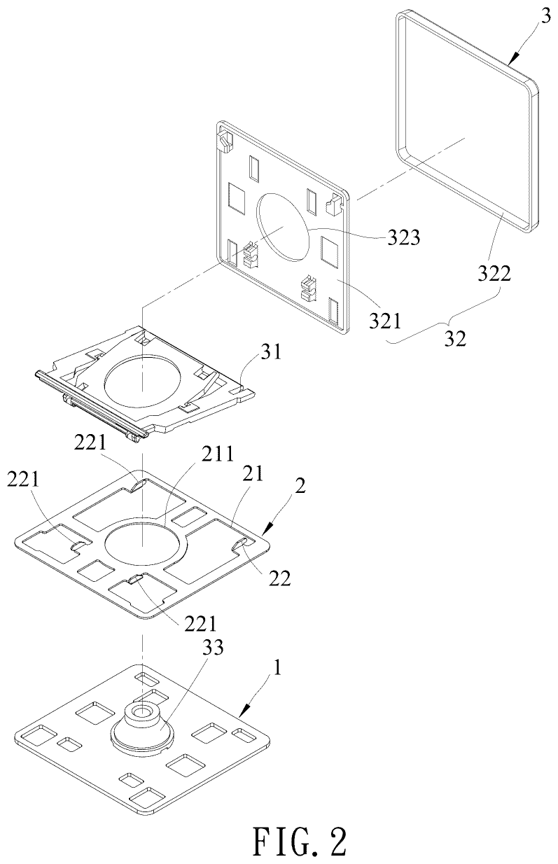

Referring to FIGS. 1 and 2, a key device according to an embodiment of the disclosure includes a circuit board unit 1, a base unit 2, and a key unit 3.

The circuit board unit 1 includes a membrane circuit board (not shown) and a backlight module (not shown). In this embodiment, the circuit board unit 1 is a two-in-one liquid-proof backlight circuit board.

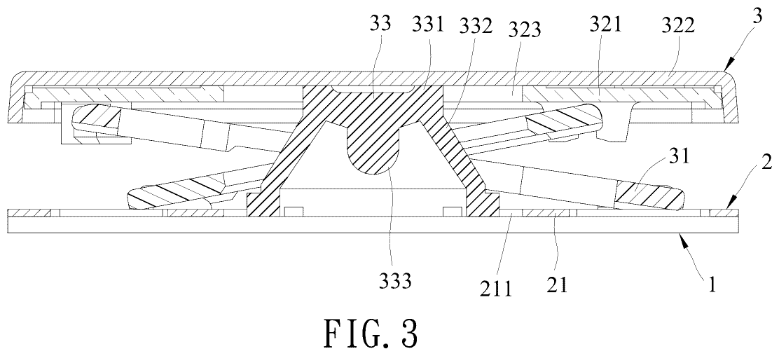

Referring to FIG. 3 in combination with FIG. 2, the base unit 2 is disposed above the circuit board unit 1, and has a base plate 21 and a hook module 22. The base plate 21 has a base opening 211. The hook module 22 is disposed on the base plate 21 and has a plurality of hooks 221. Each of the base plate 21 and the hook module 22 is made of a metal material. Specifically, the base unit 2 is adhered to the circuit board unit 1.

The key unit 3 includes a support module 31, a keycap module 32, and an elastic member 33.

The support module 31 is disposed on the base unit 2. The support module 31 is a scissor-type mechanism and is connected to the hooks 221 of the hook module 22

The keycap module 32 is disposed on the support module 31, and has a lower cap body 321 and an upper cap body 322. The lower cap body 321 is disposed on the support module 31 and has a through hole 323. The upper cap body 322 is disposed above the lower cap body 321 such that a top surface and a peripheral surface of the lower cap body 321 is covered by the upper cap body 322. The lower cap body 321 is made of a plastic material and is light permissible. The upper cap body 322 is made of a metal material. Specifically, the upper cap body 322 is made of an aluminum material.

The elastic member 33 has a bottom end that extends through the base opening 211 of the base unit 2 and that abuts against the circuit board unit 1, and a top end that extends through the through hole 323 of the lower cap body 321 and that abuts against the upper cap body 322. Specifically, the elastic member 33 has a top portion 331, a hollow cover portion 332, and a protrusion 333. The top portion 331 extends through the through hole 323 of the lower cap body 321 and abuts against the upper cap body 322. A top end of the top portion 331 is the top end of the elastic member 33. The hollow cover portion 332 extends downwardly from the top portion 311, extends through the base opening 211 of the base unit 2, and abuts against the circuit board unit 1. A bottom end of the hollow cover portion 332 is the bottom end of the elastic member 33. The protrusion 333 extends downwardly from the top portion 311, is disposed in the hollow cover portion 322, and is aligned with the base opening 211 of the base unit 2. When the upper cap body 322 is pressed, the protrusion 333 of the elastic member 33 is compressed against the circuit board unit 1 so as to generate an electrical signal.

By virtue of the elastic member 33 abutting against the upper cap body 322 and the circuit board unit 1, a thickness of the key device may remain, and a travel distance of the key device of the disclosure may be increased so as to enhance key pressing feedback and a tactile response. The details will be described below.

To increase the travel distance of the key device of the disclosure, the elastic member 33 may be lengthened. However, lengthening of the elastic member 33 results in thickening of the key device. In this embodiment, because the upper cap body 322 of the keycap module 32 is made of a metal material, because the base unit 2 is disposed above the circuit board unit 1 and has the base opening 211, and because the hollow cover portion 332 of the elastic member 33 abuts against the circuit board unit 1 through the base opening 211 of the base unit 2, the travel distance of key device may be increased while remaining the overall thickness of the key device.

By virtue of the upper cap body 322 being made of the aluminum material, in comparison with a plastic material, the upper cap body 322 may be easily processed by stamping so as to be relatively thin and have satisfactory flatness. Furthermore, because of the aluminum material, a surface of the upper cap body 322 may be easily processed for surface treatment such as an anodized finish or a brushed finish so as to increase appearance quality. In addition, because the top portion 331 of the elastic member 33 extends through the through hole 323 of the lower cap body 321 and abuts against the upper cap body 322, the top portion 331 of the elastic member 33 is unaffected by a thickness of the lower cap body 321. As a result, by virtue of the upper cap body 322 being relatively thin, the keycap module 32 is reduced in thickness. It should be noted that the upper cap body 322 is not limited to be made of the aluminum material. In other embodiments, the upper cap body 322 may be made of a thin and lightweight metal material such as a SUS304 stainless steel or another type stainless steel.

Because the circuit board unit 1 is disposed below the base unit 2, because the hollow cover portion 332 of the elastic member 33 extends through the base opening 211 of the base unit 2 and abuts against the circuit board unit 1, and because the protrusion 333 is aligned with the base opening 211 of the base unit 2, the hollow cover portion 332 of the elastic member 33 is unaffected by a thickness of the base unit 2. As a result, a size of the elastic member 33 does not need to be changed.

In comparison with the existing key device, when an overall thickness of the key device of the disclosure is equal to an overall thickness of the existing key device, the travel distance of the key device of the disclosure is longer than that of the existing key device. When the travel distance of the key device of the disclosure is equal to that of the existing key device, the overall thickness of the key device of the disclosure is smaller than that of the existing key device.

In this embodiment, the key device of the disclosure has the overall thickness of 3.35 mm and the travel distance of 1.8 mm, thereby achieving effective and optimal reduction in thickness.

The key device of the disclosure has the following advantages.

1. Because the keycap module 32 includes the lower cap body 321 and the upper cap body 322, because the circuit board unit 1 is disposed below the base unit 2, because the top end of the elastic member 33 abuts against the upper cap body 322 through the through hole 323 of the lower cap body 321, and because the bottom end of the elastic member 33 abuts against the circuit board unit 1 through the base opening 211 of the base unit 2, the overall thickness of the key device of the disclosure is optimally reduced in thickness to achieve effects of the relatively large travel distance and optimal pressing feedback.

2. Because the base unit 2 is disposed above the circuit board unit 1, the circuit board unit 1 does not need to have holes for the hooks 221 of the hook module 22 to extend therethrough. As a result, an entire surface of the circuit board unit 1 may be evenly brushed with glue to avoid occurrence of bubbles or marks, thereby improving adhesion between the circuit board unit 1 and the base unit 2. Consequently, the key device of the disclosure further has a water-resistance effect and a salt spray resistance effect.

3. In this embodiment, the circuit board unit 1 is the two-in-one liquid-proof backlight circuit board that includes the membrane circuit board (not shown) and a backlight module (not shown). During manufacturing of an illuminated keyboard (not shown), the base unit 2 may be first manufactured and stored. When the illuminated keyboard (not shown) needs to be delivered, the circuit board unit 1 is glued to a bottom surface of the base unit 2 for delivery. The key device of the disclosure facilitates assembling of the illuminated keyboard (not shown).

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A key device comprising:
a circuit board unit;
a base unit that is disposed above said circuit board unit and that has a base opening; and
a key unit that includes
a support module disposed on said base unit,
a keycap module disposed on said support module and having
a lower cap body that is disposed on said support module and that has a through hole, and
an upper cap body that is disposed above said lower cap body, and
an elastic member having
a bottom end that extends through said base opening of said base unit and that abuts against said circuit board unit, and
a top end that extends through said through hole of said lower cap body and that abuts against said upper cap body.

2. The key device as claimed in claim 1, wherein said upper cap body is made of a metal material.

3. The key device as claimed in claim 2, wherein said upper cap body is made of an aluminum material.

4. The key device as claimed in claim 2, wherein said lower cap body is made of a plastic material and is light permissible.

5. The key device as claimed in claim 1, wherein said elastic member has
a top portion that extends through said through hole of said lower cap body and that abuts against said upper cap body, a top end of said top portion being said top end of said elastic member,
a hollow cover portion that extends downwardly from said top portion, that extends through said base opening of said base unit, and that abuts against said circuit board unit, a bottom end of said hollow cover portion being said bottom end of said elastic member, and
a protrusion that extends downwardly from said top portion, that is disposed in said hollow cover portion, and that is aligned with said base opening of said base unit.

6. The key device as claimed in claim 1, wherein:
said base unit has
a base plate that has said base opening, and
a hook module that is disposed on said base plate; and
said support module is a scissor-type mechanism and is connected to said hook module.
